(19) United States
(12) Patent Application Publication
(10) Pub. No.: US 2012/0014022 A1
(43) Pub. Date: Jan. 19, 2012

(54) INTEGRATED POWER SUPPLY PROTECTION CIRCUIT WITH FAULT DETECTION CAPABILITY

(75) Inventors: Jeng-Hua Lin, Columbus, OH (US); Russell Vires, Powell, OH (US); Cyrill Bucher, Fehraltorf (CH)

(73) Assignee: METTLER-TOLEDO, INC., Columbus, OH (US)

(21) Appl. No.: 12/835,630

(22) Filed: Jul. 13, 2010

(51) Int. Cl. H02H 3/20; H02H 3/24

(52) U.S. Cl. 361/91.1; 361/92

(57) ABSTRACT

An electrical circuit to minimize the damage to internal electronics in the event of a lightning strike or power surge that may flow into the unit through the home run cable used to supply power to device loads, for example load cells and weigh terminals. The circuitry can not only protect, but it can also detect and distinguish from several overvoltage and undervoltage conditions that can occur.

### BACKGROUND OF THE INVENTIVE FIELD

The present invention is directed to a system and method for circuit protection, fault detection, and fault categorization while supplying power to a network of loads, such as load cells.

The circuit board of the present invention is comprised of circuitry that is intended to help minimize the damage to internal electronics in the event of a lightning strike or power surge that may flow into the unit through the home run cable used to supply power to device loads, for example load cells and weigh terminals such as the METTLER TOLEDO IND780 PDX. In the preferred embodiment, the circuitry can not only protect, but it can also detect and distinguish from several conditions that can occur. These conditions can be:
A minor overvoltage or overcurrent condition—caused by, for example, a mild or distant lightning strike, spurious voltage surge or a quick short circuit.
A major overvoltage or overcurrent condition—caused by, for example, a more intense, closer lightning strike or long term short circuit.
An undervoltage condition—caused by, for example, a lightning strike (negative polarity) or a loading down of the power supply by other devices in the load.

This information can be collected and used to count how often the circuit has protected the load from potentially damaging events and to categorize them into minor or major events. This information is valuable to a customer who may experience many of these events. Based on this information, the customer may take extra steps to reduce these events and prolong the life of the load device as well as other equipment that could be affected.

The present invention is designed to:
Increase the protection for a higher surge current—which increases reliability;
Have the ability to know when a surge condition occurred—and quantify to the customer the value of the surge protection;
Support a non-incendive rating for Hazardous area Division 2 requirements—allowing more value to the customer by providing a system that is easier to install and less costly.

In the preferred embodiment, the circuit of the present invention is comprised of integrated controllers that reduce the amount of space required for the circuit, has a lower in-line output voltage drop, and provides higher lightning surge current protection and more overvoltage/undervoltage protection range.

In one embodiment, a pair of power N-channel FETs linked back-to-back lowers the forward voltage drop. At an on-state, the forward drop can be 10 times less than a Schottky diode drop. At an off-state, an inherent diode of each FET can block the back current even if caused by positive or negative voltage.

In the preferred embodiment, the circuit of the present invention can survive a current surge from a lightning strike (e.g., up to 80 KA).

In one embodiment, the integrated hardware and software can monitor the fluctuation of output power and record/report a minor power surge or major power fail condition. Hardware may be adapted to respond by turning the output power off. Preferably, software periodically attempts to turn the power on after being shut down, thus restoring normal operation. The details of these events may be stored in memory and log files.

The preferred embodiment of the circuitry of the present invention will provide protection from higher current lightning strikes. This will be particularly useful in equipment that is used or connected to other equipment that is outdoors, such as truck and rail scales.

### SUMMARY OF THE GENERAL INVENTIVE CONCEPT

In one embodiment of the present invention, the invention is comprised of an electrical circuit for protecting a connected power supply and other electronics on the printed circuited board (PCB) (e.g., can driver) from power surges, comprising an input terminal for connecting to a power supply; an output terminal for connecting to a load to be powered by the power supply; a voltage sense circuit coupled to the output terminal for detecting the voltage at the output of the electrical circuit; a controller circuit coupled to the voltage sense circuit; a switch circuit for switching power on and off between the power supply and load; and where the controller circuit turns off the switch circuit when an overvoltage condition is detected at the output of the circuit and where the switch circuit is comprised of a current limiting element that is adapted to block the back current from the output of the circuit.

In one embodiment, the load is a load cell. The voltage sense circuit, in one embodiment, is comprised of a voltage divider coupled to a voltage amplifier.

In one embodiment, the control logic circuit coupled to the switch circuit turns the switch off when a predetermined signal is received at the control logic circuit. The switch circuit in the preferred embodiment is a pair of N-channel MOSFETs inversely connected in series between the input terminal and output terminal.

The electric circuit of the present invention, in the preferred embodiment, has a current sense circuit for detecting an overcurrent condition on the power output.

In the preferred embodiment, the voltage sense circuit and controller circuit is configured to turn the switch circuit off for a major overvoltage condition and to allow the switch circuit to remain on for a minor overvoltage condition.

In the preferred embodiment, the present invention is also comprised of a data collection microcontroller in communication with the controller circuit for collecting data on the number of major overvoltage conditions (an overvoltage condition is also referred to as a positive surge condition) at the output terminal of the circuit, and the number of major undervoltage conditions (an undervoltage condition is also referred to as a negative surge condition) at the output terminal of the circuit. The data collection microcontroller also collects data on the number of minor overvoltage conditions at the output terminal of the circuit and the number of minor undervoltage conditions at the output terminal of the circuit.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 illustrates one embodiment of a 12V power supply protection circuit of the present invention;

FIG. 2 illustrates one embodiment of a 24V power supply protection circuit; and

FIG. 3 illustrates the circuit diagram of the LINEAR TECHNOLOGY Integrated Controller used in the example embodiment of the present invention.

### DETAILED DESCRIPTION OF EXEMPLARY EMBODIMENT(S)

In one embodiment of the present invention, the circuit can supply 12V directly to the load or 24V if an external power supply is used. Different lines are provided on the output connector for 12V or 24V. In the preferred embodiment, the 12V line will be approved as non-incendive, whereas the 24V will be an incendive output. In an example embodiment, the lightning protection circuitry is mostly separate for the 12V and 24V due to the differing protection values needed. The microprocessor can select which voltage to use and the selected voltage can then be turned on/off. In the preferred embodiment, a single A/D converter (inside microcontroller) is used to measure the voltage that is turned on.

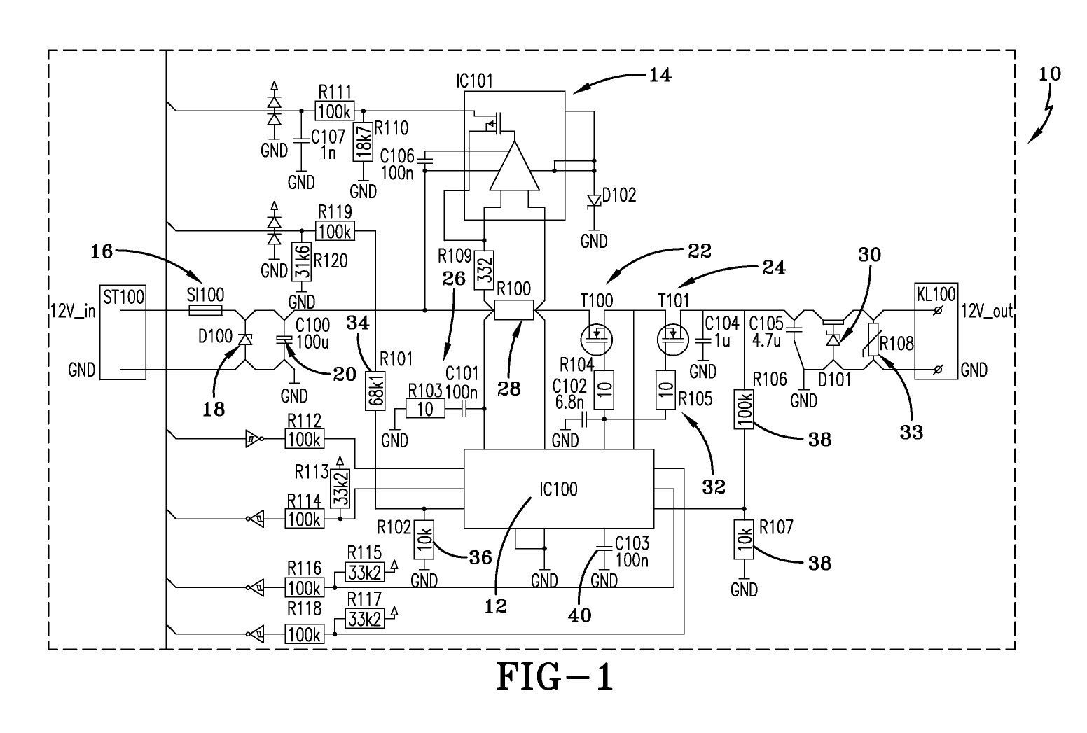

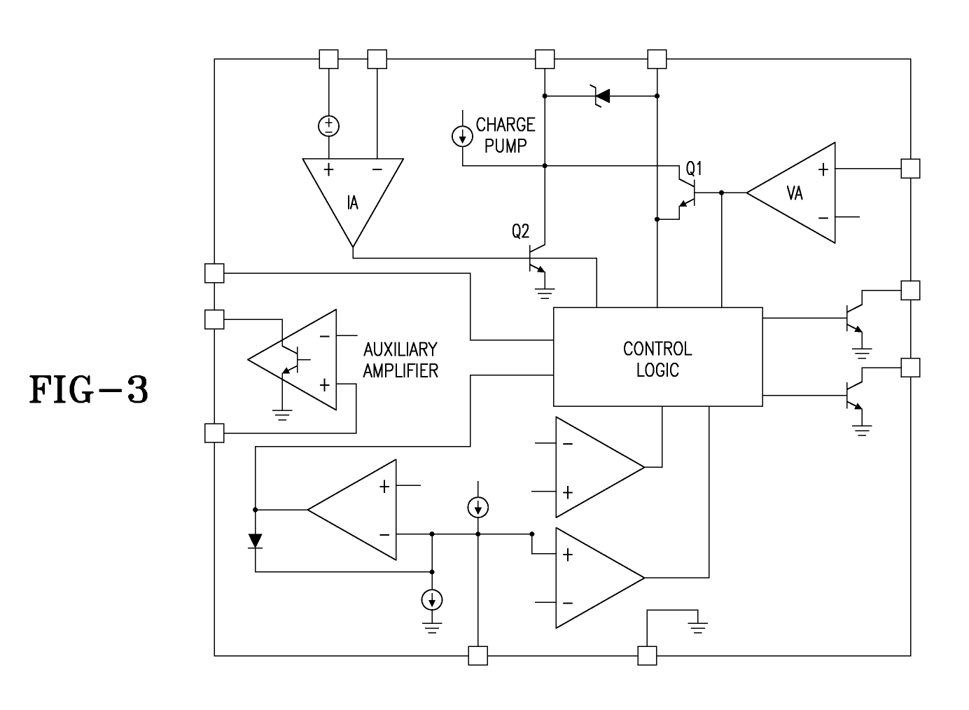

The present invention provides higher level surge protection. For the 12 V case, refer to FIG. 1, the Power Supply 12V section at 10—(12 V power is prepared for output). The input is on the left (connected to the power supply) and the output is on the right (connected to the load). In the preferred embodiment, the following devices are used in the circuit along the output power path to protect the 12V power source from in-coming surge damage.
Varistor (R108) at the far right shown at 33 is a CT2220K20G from EPCOS. It is 20Vᵣₘₛ/1200 Aₘₐₓ rated. This varistor provides relatively low clamping voltage (+80V or −80V) during a strike pulse like lightning, thus limiting very large voltages to ±80V.
The Schottky diode (D101) at 30 with a rating of 100V/10 A (150 Aₚₑₐₖ) further limits a −80V pulse to about −2V. During such a lightning pulse the maximum current through (D101) can reach ˜120 A. For this reason a large package for D101 is preferably selected.
The two N-channel MOSFETs (T100, T101) shown at 22, 24, each in an SO-8 case, have ratings of V_{DSS}=100V, I_{D}=6.9 A and R_{DS(on)} max=26 mΩ @V_{GS}=10V. The source pins of T100 and T101 are joined in the middle, while the drain pin of T101 is the power output from the system.
The current sensing resistor R100 at 28 is inserted between the fuse (ST100) at 16 and the drain pin of T100. Overcurrent protection is triggered whenever the surge current is over the threshold (threshold of the example design is about 550 mA).
Transient Voltage Suppressor diode D100 at 18 is attached to the input GND and the point on the path between the fuse ST100 and current-sensing resistor R100. D100 starts to conduct if the voltage is higher than a certain voltage (e.g., 13.3V).
IC100 shown at 12, a highly integrated circuit surge stopper (e.g., the LT4356-1 integrated chip from LINEAR TECHNOLOGY) is applied to protect the power source from outside surge pulses. Inside the chip (see FIG. 3), two major circuit blocks are used for limiting the affects of the surge. The IA (current amplifier) with FET gate control transistor Q2 and the VA with FET gate regulating transistor Q1. The other circuit blocks, such as the gate logic control timer and auxiliary voltage comparator are used to identify the surge condition and provide for power recovery. The IC's rating of 80V/−30V is sufficient with the other protections as identified in the circuitry.
The fuse is the last defense for the 12V power source if the lightning strike pulse/surge does pass all the front end protections.
C100 at 20 provides filtering of the power near the fuse (ST100). C102, R104 and R105 shown at 32 filter the noise at the gate pins of MOSFETs (T100 and T101). C105 filters the noise near the output.

If the Two Gates of T100 and T101 are Switched Off:

If the surge or strike pulse is an overvoltage condition—the surge pulse at the power output pin will be less than +80V due to R108. The predicted maximum voltage across the switched off MOSFET (T101) is 80V, thus the MOSFET's 100 V rating is sufficient. The diode T101 blocks the surge pulse from reaching the joined source pins of the two MOSFETs.

If the surge or strike pulse is an undervoltage condition—the negative surge pulse will be reduced to about −2V at the joined source pins of T100 and T101 due to R108 and D101. The maximum voltage across the switched-off MOSFET (T100) would be less than ˜15V, within the MOSFET's 100V rating. T100 blocks the surge pulse from reaching the current sensing resistor (R100).

If the Two Gates of T100 and T101 are Switched on:

If the surge pulse is an overvoltage condition there are three conditions to consider:
a) Fast surge pulse (within 10 uS) between ˜22V and ˜80V
b) Fast surge pulse (within 10 uS) between ˜12V and ˜22V
c) Slow surge pulse (greater than 10 uS) between ˜12V and ˜80V
   In condition a), the positive surge pulse may reach the joined source pins of T100 and T101. This consequently raises the source voltage, and the MOSFETs are turned off due to the reduced V_{GS}. The transient Voltage Suppressor diode D100 also contributes in keeping the MOSFETs' Gate level from increasing with the surge which helps in turning off the MOSFETs. The fast response time (˜29 nS) of the N-type MOSFET also helps in turning off the circuit in a short period of time to protect the power supply.

This has been tested by subjecting the circuit to more than 50 severe simulated lightning strikes (10 KA current rise within ˜8 uS). The results show all the components on the power path, such as the MOSFETs, maintained good functionality and fully protected the power supply.

In condition b), the surge pulse may not be high enough for the MOSFETs to be directly turned off due to the reduced V_{GS}. In this case additional protection is provided by use of IC100. If the voltage on the feedback (FB) pin and the voltage comparator (VA) exceeds the level threshold of 13.75V (from voltage divider at 38 formed by resistors R106 and R107), the transistor Q1 for controlling GATE level, driven by (VA) will turn off. This causes MOSFET's T100 and T101 to turn off, thus protecting the power supply.

In condition c), the surge pulse may increase more slowly and vary in the voltage level. The combination of these factors will determine whether the protection method of condition a) or condition b) will apply to protect the power supply. Thus, the multiple methods of protection used in the circuitry will provide adequate protection for the power supply in a wide variety and range of circumstances.

If the surge pulse is an undervoltage condition—the overcurrent protection of IC100 will function. With the MOSFETs T100 and T101 turned on, the negative voltage on the output will cause the current across the sensing resistor R100 to be over the limit. This overcurrent condition is sensed by (IA) which drives the transistor Q2 to be off and GATE level voltage becomes OV. This causes MOSFET's T100 and T101 to turn off, thus protecting the power supply.

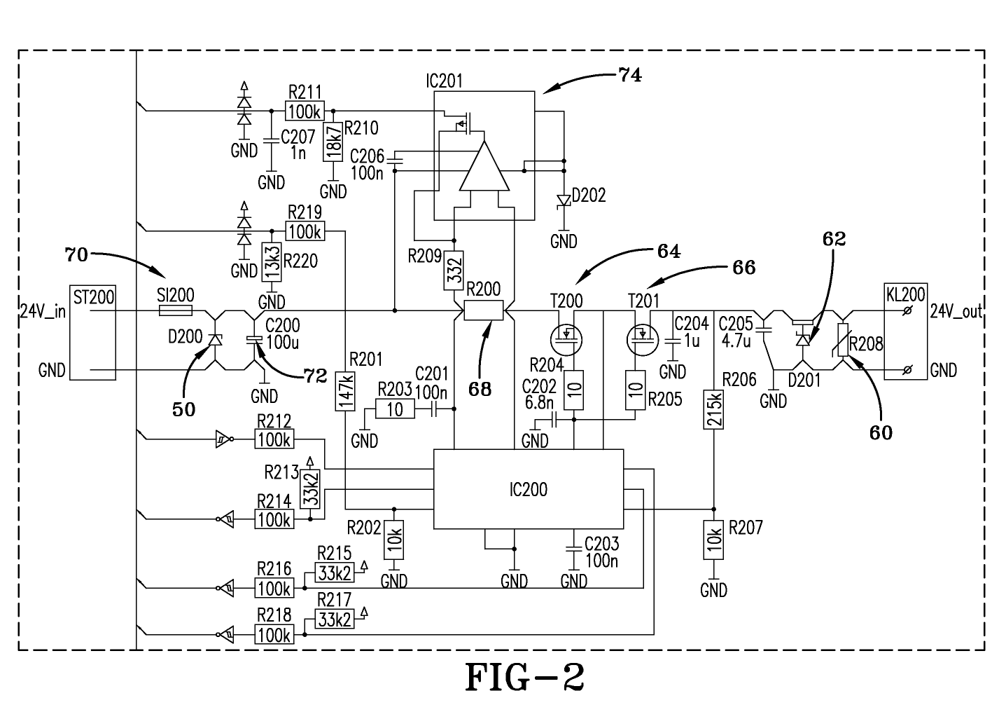

For the 24 V case, refer to FIG. 2, Power Supply 24V section—(24 V power is prepared for output). The input is on the left and the output is on the right. In the preferred embodiment, the following devices are used in the circuit along the output power path to protect the 24V power source from in-coming surge damage:
Varistor (R208) at the far right shown at 60 is a CT2220K20G from EPCOS. It is 20Vᵣₘₛ/1200 Aₘₐₓ rated. This varistor provides relatively low clamping voltage (+80V or −80V) during a strike pulse like lightning, thus limiting very large voltages to ±80V.
The Schottky diode (D201) at 62 with a rating of 100V/10 A (150 Aₚₑₐₖ) further limits a −80V pulse to about −2V. During such a lightning pulse the maximum current through (D201) can reach ˜120 A. For this reason a large package for D201 is preferably selected.
The two N-channel MOSFETs (T200, T201) at 64, 66, each in an SO-8 case, have ratings of V_{DSS}=100V, I_{D}=6.9 A and R_{DS(on)} max=26 mΩ @ V_{GS}=10V. The source pins of T200 and T201 are joined in the middle, while the drain pin of T201 is the power output from the system.
The current sensing resistor R200 at 68 is inserted between the fuse (ST200) at 70 and the drain pin of T200. Overcurrent protection is triggered whenever the surge current is over the threshold of about 2 Amp.
Transient Voltage Suppressor diode D200 at 50 is attached to the input GND and the point on the path between the fuse ST200 and current-sensing resistor R200. D200 starts to conduct if the voltage is higher than a certain voltage (e.g., 26.7V).
IC200, a highly integrated circuit surge stopper is applied here to protect the power source from outside surge pulses. Inside the chip (see FIG. 3), two major circuit blocks are used for limiting the affects of the surge. The IA (current amplifier) with FET gate control transistor Q2 and the VA with FET gate regulating transistor Q1. The other circuit blocks, such as the gate logic control timer and auxiliary voltage comparator are used to identify the surge condition and provide for power recovery. The IC's rating of 80V/−30V is sufficient with the other protections as identified in the circuitry.
The fuse is the last defense for the 24V power source if the lightning strike pulse/surge does pass all the front end protections.
C200 at 72 provides filtering of the power near the fuse (ST200). C202, R204 and R205 filter the noise at the gate pins of MOSFETs (T200 and T201). C205 filters the noise near the output.

If the Two Gates of T200 and T201 are Switched Off:

If the surge or strike pulse is an overvoltage condition—the surge pulse at the power output pin will be less than +80V due to R208. The predicted maximum voltage across the switched off MOSFET (T201) is 80V, thus the MOSFET's 100 V rating is sufficient. The diode T201 blocks the surge pulse from reaching the joined source pins of the two MOSFETs.

If the surge or strike pulse is an undervoltage condition—the negative surge pulse will be reduced to about −2V at the joined source pins of T200 and T201 due to R208 and D201. The maximum voltage across the switched-off MOSFET (T200) would be less than ˜28V, within the MOSFET's 100V rating. T200 blocks the surge pulse from reaching the current sensing resistor (R200).

If the Two Gates of T200 and T201 are Switched on:

If the surge pulse is an overvoltage condition there are three conditions to consider:

a) Fast surge pulse (within 10 uS) between ˜34V and ˜80V
b) Fast surge pulse (within 10 uS) between ˜24V and ˜34V
c) Slow surge pulse (greater than 10 uS) between ˜24V and ˜80V

In condition a), the positive surge pulse may reach the joined source pins of T200 and T201. This consequently raises the source voltage, and the MOSFETs are turned off due to the reduced V_{GS}. The transient Voltage Suppressor diode D200 also contributes in keeping the MOSFETs' Gate level from increasing with the surge which helps in turning off the MOSFETs. The fast response time (˜29 nS) of the N-type MOSFET also helps in turning off the circuit in a short period of time to protect the power supply.

In condition b), the surge pulse may not be high enough for the MOSFETs to be directly turned off due to the reduced V_{GS}. In this case additional protection is provided by use of IC200. If the voltage on the feedback (FB) pin and the voltage comparator (VA) exceeds the level threshold of 28.13V (from voltage divider resistors R206 and R207), the transistor Q1 for controlling GATE level, driven by (VA) will turn off. This causes MOSFET's T200 and T201 to turn off, thus protecting the power supply.

In condition c), the surge pulse may increase more slowly and vary in the voltage level. The combination of these factors will determine whether the protection method of condition a) or condition b) will apply to protect the power supply. Thus, the multiple methods of protection used in the circuitry will provide adequate protection for the power supply in a wide variety and range of circumstances.

If the surge pulse is an undervoltage condition—the overcurrent protection of IC200 will function. With the MOSFETs T200 and T201 turned on, the negative voltage on the output will cause the current across the sensing resistor R200 to be over the limit. This overcurrent condition is sensed by (IA) which drives the transistor Q2 to be off and GATE level voltage becomes OV. This causes MOSFET's T200 and T201 to turn off, thus protecting the power supply.

Identification, Logging and Recovery from Power Fail Conditions Caused by High Current Surges:

For the 12 V case, again refer to FIG. 1. In the preferred embodiment, for an undervoltage condition, IC100, resistors R101, and R102, and microcontroller are the components that provide the ability to monitor, detect, log, and recover from an undervoltage condition. In one embodiment, the microcontroller is a data collection microcontroller, for example a LPC2366 chip, in communication with the circuit of the present invention.

R101 and R102 at 34, 36 form a voltage divider and their joined point connects to the +IN pin of IC100. Inside IC100, an auxiliary amplifier compares the +IN level to a fixed 1.25V. By selecting the proper values of R101 and R102, the output (AOUT pin) of this comparator will sink current and become logic low whenever the supply voltage goes below +9.7V. This undervoltage detection signal (UV_{—}12V) of IC100 generates an interrupt to the on board microcontroller to execute the undervoltage interrupt routine and handle the error. The microcontroller will monitor the voltage using one of the internal A/D converters to classify and log this as a minor or major undervoltage event. If the voltage remains low for more than a predetermined period of time, the microcontroller will log this as a major undervoltage event and will turn off the output power using the shut-down signal (*SHDN) of IC100. When the cause of the undervoltage condition is removed and the +12V power returns to nominal, the microcontroller deactivates (*SHDN) of IC100 restoring power out to the network.

For an overvoltage/overcurrent condition, IC100, microcontroller, precise current sensor IC101 at 14 (in one embodiment shown in FIG. 1, IC101 is a current sense amplifier LTC6102), resistors R109, and R110 are the components in the preferred embodiment that provide the ability to monitor, detect, log, and recover from an overvoltage or overcurrent condition.

In the event of an overvoltage/overcurrent condition, IC100, in addition to controlling the MOSFETs as described above, will set the *FLT pin output to a logic low state. This overvoltage/overcurrent detection signal (*FLT) generates an interrupt to the microcontroller to execute the overvoltage/overcurrent interrupt routine and handle the error. The microcontroller monitors the current (using IC101 in conjunction with resistors R109 and R110) and the voltage to classify and log this as a minor or major overvoltage/overcurrent event. If the voltage or current remains high for more than a predetermined period of time, the microcontroller will log this as a major overvoltage/overcurrent event and will turn off the output power using the shut-down signal (*SHDN) of IC100. Accordingly, when there is an overvoltage surge+event situation at the output (e.g., from a lightning strike at the load), the integrated controller IC100 detects this condition, and turns off the MOSFETs. At an off-state, an inherent diode of each MOSFET can block the back current even if caused by positive or negative voltage, thus protecting the power supply, and other associated circuits, from this overvoltage condition.

When the cause of the overvoltage/overcurrent condition is removed and the +12V power returns to nominal, the microcontroller deactivates (*SHDN) of IC100 restoring power out to the network.

For the 24 V case, again refer to FIG. 2. For an undervoltage Condition, IC200, resistors R201, and R202, and Micro-Controller are the components in the preferred embodiment, that provide the ability to monitor, detect, log, and recover from an undervoltage condition.

R201 and R202 form a voltage divider and their joined point connects to the +IN pin of IC200. Inside IC200, an Auxiliary Amplifier compares the +IN level to a fixed 1.25V. By selecting the proper values of R201 and R202, the output (AOUT pin) of this comparator will sink current and become logic low whenever the supply voltage goes below +19.63V. This undervoltage detection signal (UV_{—}24V) of IC200 generates an interrupt to the on board microcontroller to execute the undervoltage interrupt routine and handle the error. The microcontroller will monitor the voltage using one of the internal A/D converters to classify and log this as a minor or major undervoltage event. If the voltage remains low for more than a predetermined period of time, the microcontroller will log this as a major undervoltage event and will turn off the output power using the shut-down signal (*SHDN) of IC200. When the cause of the undervoltage condition is removed and the +24V power returns to nominal, the microcontroller deactivates (*SHDN) of IC200 restoring power out to the network.

For an overvoltage/overcurrent condition, IC200, microcontroller, precise current sensor IC201 at 74 (in one embodiment shown in FIG. 2, IC201 is a current sense amplifier LTC6102), resistors R209, and R210 are the components in the preferred embodiment that provide the ability to monitor, detect, log, and recover from an overvoltage or overcurrent condition.

In the event of an overvoltage/overcurrent condition, IC200, in addition to controlling the MOSFETs as described above, will set the *FLT pin output to a logic low state. This overvoltage/overcurrent detection signal (*FLT) generates an interrupt to the microcontroller to execute the overvoltage/overcurrent interrupt routine and handle the error. The microcontroller monitors the current (using IC201 in conjunction with resistors R209 and R210) and the voltage to classify and log this as a minor or major overvoltage/overcurrent event. If the voltage or current remains high for more than a predetermined period of time, the microcontroller will log this as a major overvoltage/overcurrent event and will turn off the output power using the shut-down signal (*SHDN) of IC200. When the cause of the overvoltage/overcurrent condition is removed and the +24V power returns to nominal, the microcontroller deactivates (*SHDN) of IC200 restoring power out to the network.

Resistor (R103) and capacitor (C101) form a snubber network 26 at the VCC input of the integrated controller to prevent destructive overvoltages due to lead and track inductances when load currents are switched quickly.

In the preferred embodiment, capacitor (C103) 40 is a timer capacitor which is charged with a MOSFET stress dependent current. In this embodiment, if the voltage at (C103) reaches 1.25V, the *FLT pin of the integrated controller is activated to signal a fault. If the situation persists and the voltage at (C103) reaches 1.35V the MOSFETS are switched off completely.

While certain embodiments of the present invention are described in detail above, the scope of the invention is not to be considered limited by such disclosure, and modifications are possible without departing from the spirit of the invention as evidenced by the following claims:

What is claimed is:

1. An electrical circuit for protecting a connected power supply from power surges, comprising:
an input terminal for connecting to a power supply;
an output terminal for connecting to a load to be powered by the power supply;
a voltage sense circuit coupled to the output terminal for detecting the voltage at the output of the electrical circuit;
a controller circuit coupled to the voltage sense circuit;
a switch circuit for switching power on and off between the power supply and load; and
wherein the controller circuit turns off the switch circuit when an overvoltage condition is detected at the output of the circuit and wherein the switch circuit is comprised of a current limiting element that is adapted to block the back current from the output of the circuit.

2. The electrical circuit according to claim 1, wherein the load is a load cell.

3. The electrical circuit according to claim 1, wherein the voltage sense circuit is comprised of:
a voltage divider coupled to a voltage amplifier.

4. The electrical circuit according to claim 1, wherein the controller circuit is comprised of:
a control logic circuit coupled to the switch circuit for turning the switch off when a predetermined signal is received at the control logic circuit.

5. The electrical circuit according to claim 1, wherein the switch circuit is comprised of:
a pair of N-channel MOSFETs inversely connected in series between the input terminal and output terminal.

6. The electrical circuit according to claim 1, further comprising:
a current sense circuit for detecting an overcurrent condition at the output terminal of the circuit.

7. The electrical circuit according to claim 1, wherein the voltage sense circuit and controller circuit is configured to turn the switch circuit off for a major overvoltage condition and to allow the switch circuit to remain on for a minor overvoltage condition.

8. The electrical circuit according to claim 1, further comprising:
a data collection microcontroller in data communication with the controller circuit for collecting data on the number of major overvoltage conditions at the output terminal of the circuit and the number of minor overvoltage conditions at the output terminal of the circuit.

9. The electrical circuit according to claim 8, further comprising:
a data collection microcontroller in data communication with the controller circuit that collects data on the number of major undervoltage conditions at the output terminal of the circuit and the number of minor undervoltage conditions at the output terminal of the circuit.

10. An electrical circuit for protecting a connected power supply from power surges, comprising:
an input terminal for connecting to a power supply;
an output terminal for connecting to a load to be powered by the power supply;
a voltage sense circuit coupled to the output terminal for detecting the voltage at the output of the electrical circuit;
a controller circuit coupled to the voltage sense circuit;
a switch circuit for switching power on and off between the power supply and load;
wherein the controller circuit turns off the switch circuit when an undervoltage condition is detected at the output of the circuit and wherein the switch circuit is comprised of a current sensing element for comparing the current to a threshold and shutting off the switch circuit when the current is above the threshold; and
wherein the switch circuit is comprised of a pair of N-channel MOSFETs inversely connected in series between the input terminal and output terminal.

11. The electrical circuit according to claim 10, wherein the switch circuit is comprised of an inherent diode in one of the N-channel MOSFETs.

12. A method for protecting a connected power supply from power surges originating at a load, comprising the steps of:
sensing the voltage at the load;
switching power off between the power supply and load when an overvoltage condition is detected; and
blocking the back current from the load when a overvoltage condition is detected.

13. The method according to claim 12, further comprising the steps of:
providing power to a load cell; and
protecting the power supply from power surges originating at the load cell.

14. The method according to claim 12, further comprising the steps of:
sensing the current of the power supply; and
detecting an overcurrent condition of the power supply.

15. The method according to claim 12, further comprising the steps of:
switching off power between the power supply and load when a major overvoltage condition is detected; and
allowing power to remain on between the power supply and load for a minor overvoltage condition.

16. The method according to claim 12, further comprising the step of:
collecting data on the number of major overvoltage conditions at the load and the number of minor overvoltage conditions at the load.

17. The method according to claim 16, further comprising the step of:
collecting data on the number of major and minor undervoltage conditions at the load.
